(19) United States
(12) Patent Application Publication
(10) Pub. No.: US 2011/0246685 A1
(43) Pub. Date: Oct. 6, 2011

(54) METHOD, APPARATUS AND SYSTEM FOR IMPROVING RUNNING STABILITY OF SAS DOMAIN

(75) Inventor: Yu HU, Chengdu (CN)

(73) Assignee: CHENGDU HUAWEI SYMANTEC TECHNOLOGIES CO., LTD., Chengdu (CN)

(21) Appl. No.: 13/163,212

(22) Filed: Jun. 17, 2011

Related U.S. Application Data
(63) Continuation of application No. PCT/CN2009/074395, filed on Oct. 10, 2009.

(30) Foreign Application Priority Data
Dec. 17, 2008 (CN) 200810241626.6

(51) Int. Cl. G06F 3/00

(52) U.S. Cl. 710/18

(57) ABSTRACT

A method, an apparatus and a system for improving running stability of a Serial Attached Small Computer System Interface (SAS) domain are disclosed. The method includes: monitoring and recording the number of state changes of each SAS physical channel in the SAS domain within a preset time; and isolating an SAS physical channel that fulfills a preset isolation condition according to the number of state changes. The method improves the running stability of the SAS domain.

### CROSS-REFERENCE TO RELATED APPLICATIONS

This application is a continuation of International Application No. PCT/CN2009/074395, filed on Oct. 10, 2009, which claims priority to Chinese Patent Application No. 200810241626.6, filed on Dec. 17, 2008, both of which are hereby incorporated by reference in their entireties.

### FIELD OF THE INVENTION

The present invention relates to the communications afield, and in particular, to a method and an apparatus for improving running stability of a Serial Attached Small Computer System Interface (SAS) domain, and a system that uses the apparatus.

### BACKGROUND OF THE INVENTION

The SAS uses the serial technology to obtain higher transmission speeds, and improves the internal space of the interface by shortening the connecting wires. The SAS interface is a new-generation serial point-to-point storage device interface of the enterprise class. The SAS interface makes the storage system application more flexible, and enables a user to select an SAS disk or a Serial Advanced Technology Attachment (SATA) disk as required. Therefore, the SAS interface increases flexibility of expanding the storage system, and maximizes cost-efficiency of the storage device. An SAS structure is highly scalable. An SAS expansion device (a component that facilitates communication between plenty of SAS devices, and includes at least two external interfaces) can be connected to up to 16,384 disk devices. A set of SAS devices which communicate through a service transmission subsystem is called an SAS domain, and the channel for connecting an SAS device to the SAS expansion device is called an SAS physical channel.

In the process of implementing the present invention, the inventor finds that in the conventional art, a request sent by each host to a destination device and a response returned by the destination device are transmitted through a point-to-point connection on a specific physical channel in the case that the storage device is connected to the SAS. When the state of an SAS physical channel changes, the transmission of data on all SAS physical channels in the whole SAS domain suspends, the performance is deteriorated seriously, and even the system is crashed. The SAS physical channels in the SAS domain can resume the normal data transmission only after the recovery of the system is completed, which affects the running stability of the system.

### SUMMARY OF THE INVENTION

The embodiments of the present invention provide a method, an apparatus, and a system for improving running stability of a SAS domain to improve the running stability of the SAS domain.

One aspect of the present invention provides a method for improving running stability of a SAS domain. The method includes: monitoring and recording the number of state changes of each SAS physical channel in the SAS domain within a preset time; and isolating a SAS physical channel that fulfills a preset isolation condition according to the number of state changes.

Another aspect of the present invention provides an apparatus for improving running stability of a SAS domain. The apparatus includes: a monitoring and recording module, configured to monitor and record the number of state changes of each SAS physical channel in the SAS domain within a preset time; and an isolating module, configured to isolate a SAS physical channel that fulfills a preset isolation condition according to a monitoring result of the monitoring and recording module.

Another aspect of the present invention provides a storage system. The storage system includes: a storage apparatus, configured to store data through at least two storage devices included in the storage apparatus, where the storage devices are connected to a stabilizing apparatus through SAS physical channels; and the stabilizing apparatus, configured to monitor and record the number of state changes of each SAS physical channel in the storage apparatus, and isolate a SAS physical channel that fulfills a preset isolation condition according to the number of state changes.

In the technical solution under the present invention, the state changes of the SAS physical channels in the SAS domain are monitored and recorded; the SAS physical channel which fulfills a specific condition within a preset time is regarded as faulty and is isolated, enabling other SAS physical channels to transmit data normally and improving the running stability of the whole SAS domain.

### BRIEF DESCRIPTION OF THE DRAWINGS

To make the technical solution under the present invention clearer, the following briefly describes the accompanying drawings involved in the description of the embodiments of the present invention. Apparently, the accompanying drawings outlined below are exemplary only and are not exhaustive, and persons of ordinary skill in the art can derive other drawings from such accompanying drawings without any creative effort.

FIG. 1 is a flow chart of a method for improving running stability of an SAS domain according to a first embodiment of the present invention;

FIG. 2 is a flow chart of a method for improving running stability of an SAS domain according to a second embodiment of the present invention;

FIG. 3 is a flow chart of a method for improving running stability of an SAS domain according to a third embodiment of the present invention;

FIG. 4 shows a structure of an apparatus for improving running stability of an SAS domain according to a fourth embodiment of the present invention;

FIG. 5 shows a structure of an apparatus for improving running stability of an SAS domain according to a fifth embodiment of the present invention;

FIG. 6 shows a structure of an apparatus for improving running stability of an SAS domain according to a sixth embodiment of the present invention; and

FIG. 7 shows a structure of a storage system according to a seventh embodiment of the present invention.

### DETAILED DESCRIPTION OF THE EMBODIMENTS

The technical solution under embodiments of the present invention is expounded below with reference to accompanying drawings. Evidently, the embodiments described below are exemplary only and not exhaustive or restrictive. All other embodiments, which can be derived by those skilled in the art from the embodiments given herein without any creative effort, fall within the protection scope of the present invention.

It should be noted that in a SAS domain, at least one SAS expansion device exists. The SAS expansion device includes a SAS expansion chip. In the SAS expansion chip, a control register is set for each SAS physical channel for controlling the SAS physical channel, and a register (monitoring register) is set for monitoring the state change of each SAS physical channel.

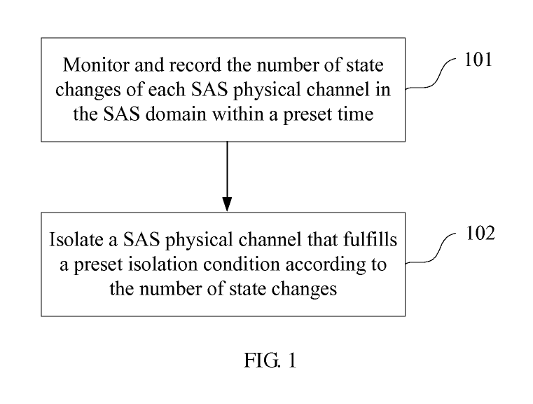

FIG. 1 is a flow chart of a method for improving running stability of a SAS domain according to a first embodiment of the present invention. As shown in FIG. 1, the method includes the following steps:

Step 101: Monitor and record the number of state changes of each SAS physical channel in the SAS domain within a preset time.

The preset time is a time period for monitoring and recording the number of state changes of each SAS physical channel. The number of state changes of the SAS physical channel may be obtained by reading values of a monitoring register corresponding to the SAS physical channel. The monitoring register stores the absolute number of state changes of the SAS physical channel, and the number of state changes of the SAS physical channel may be obtained according to the difference between the absolute numbers of two adjacent state changes of the SAS physical channel.

Step 102: Isolate a SAS physical channel that fulfills a preset isolation condition according to the number of state changes.

The isolation condition may be determined according to the device performance or the actual use conditions. If the number of state changes of a SAS physical channel within a preset time is greater than (or, greater than or equal to) a threshold, the SAS physical channel is regarded as faulty and needs to be isolated. For example, the preset time is 60s, the preset threshold is 3, and the isolation condition is that the number of state changes within 60s is greater than or equal to 3. That is, if the number of state changes of a SAS physical channel within 60s is greater than or equal to 3, the SAS physical channel is regarded as faulty and needs to be isolated. The isolation method may be: changing a value of a control register corresponding to the SAS physical channel to disable the SAS physical channel and therefore isolate the SAS physical channel.

In the foregoing technical solution, the number of state changes of the SAS physical channels in the SAS domain within a preset time is monitored and recorded; if the number of state changes of a SAS physical channel fulfills the isolation condition, the SAS physical channel is regarded as faulty and is isolated in time, enabling other SAS physical channels to transmit data normally without being affected by the faulty SAS physical channel, and improving running stability of the whole SAS domain.

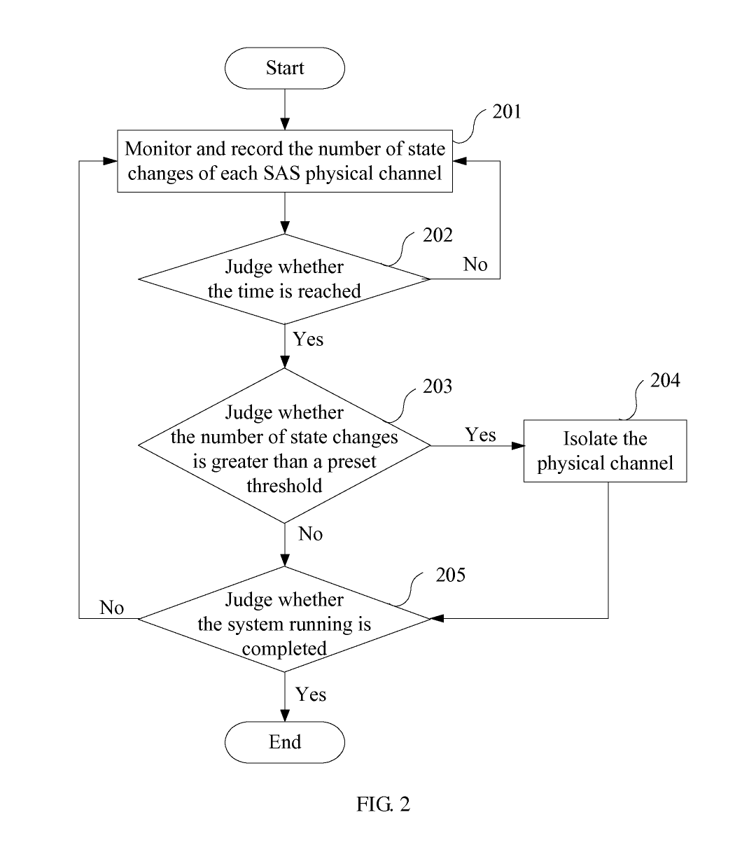

FIG. 2 is a flow chart of a method for improving running stability of a SAS domain according to a second embodiment of the present invention. As shown in FIG. 2, the method includes the following steps:

Step 201: Monitor and record the number of state changes of each SAS physical channel and proceed to step 202.

The number of state changes of each SAS physical channel may be obtained by reading values of a monitoring register corresponding to the SAS physical channel. The monitoring register stores the absolute number of state changes of the SAS physical channel, and the number of state changes of the SAS physical channel may be obtained according to the difference between the absolute numbers of two adjacent state changes of the SAS physical channel.

Step 202: Judge whether the preset time is reached. If the preset time is reached, proceed to step 203; if the preset time is not reached, continue with step 201 to monitor and record the number of state changes of each SAS physical channel.

The preset time is a time period for monitoring and recording the number of state changes of each SAS physical channel, and is a time condition for judging whether a SAS physical channel is faulty.

Step 203: Judge whether the number of state changes of the SAS physical channel is greater than a preset threshold. If the number of state changes of the SAS physical channel is greater than the preset threshold, proceed to step 204; if the number of state changes of the SAS physical channel is not greater than the preset threshold, proceed to step 205.

The isolation condition illustrated in this embodiment is: The number of state changes of the SAS physical channel within the preset time is greater than the preset threshold. The isolation condition may also be: If the number of state changes of a SAS physical channel within the preset time is greater than or equal to the threshold, the SAS physical channel is regarded as faulty and needs to be isolated. The preset time and the threshold may be determined according to the device performance or the actual use conditions. For example, the preset time is 60s, the preset threshold is 3, and the isolation condition is that the number of state changes within 60s is greater than or equal to 3. That is, if the number of state changes of a SAS physical channel within 60s is greater than or equal to 3, the SAS physical channel fulfills the isolation condition and needs to be isolated.

Step 204: Isolate the SAS physical channel and proceed to step 205.

The isolation method may be: changing a value of a control register corresponding to the SAS physical channel to disable the SAS physical channel and therefore isolate the SAS physical channel.

Step 205: Judge whether the system running is completed. If the system running is completed, end the procedure; if the system running is not completed, continue with step 201 to monitor and record the number of state changes of each SAS physical channel.

In the foregoing technical solution, the number of state changes of the SAS physical channel in the SAS domain within a preset time is monitored and recorded; and the isolation condition is set according to the number of state changes of the SAS physical channel; the SAS physical channel that fulfills the isolation condition is regarded as faulty and is isolated in time, enabling other SAS physical channels to transmit data normally without being affected by the faulty SAS physical channel, and ensuring stable running of the whole SAS domain.

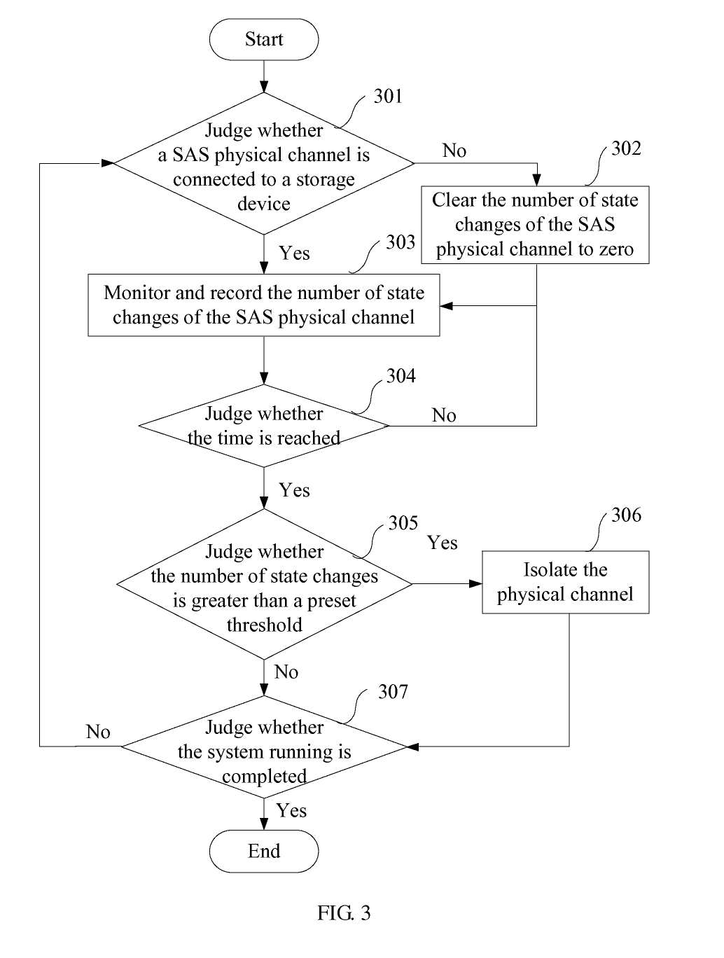

FIG. 3 is a flow chart of a method for improving running stability of a SAS domain according to a third embodiment of the present invention. As shown in FIG. 3, the method includes the following steps:

Step 301: Judge whether the SAS physical channel in the SAS domain is connected to a storage device. If the SAS physical channel in the SAS domain is connected to a storage device, proceed to step 303; if the SAS physical channel in the SAS domain is not connected to a storage device, proceed to step 302.

The judging whether the SAS physical channel is connected to a storage device is performed based on a register preset in a SAS expansion device in the SAS domain. The register monitors whether the corresponding physical channel is connected to a storage device. The storage device may be a hard disk device or a concatenated SAS expansion device.

Step 302: Clear the number of state changes of the SAS physical channel to zero and proceed to step 303.

The number of state changes of the SAS physical channel is cleared to zero so that the SAS physical channel is not mistakenly regarded as faulty or mistakenly isolated because the SAS physical channel disconnected from the storage device, such as a hard disk or a concatenated SAS expansion device when the storage device is repeatedly inserted and removed manually.

Step 303: Monitor and record the number of state changes of the SAS physical channel and proceed to step 304.

The number of state changes of the SAS physical channel can be obtained by reading values of a monitoring register corresponding to the SAS physical channel. The monitoring register stores the absolute number of state changes of the SAS physical channel, and the number of state changes of the SAS physical channel may be obtained according to the difference between the absolute numbers of two adjacent state changes of the SAS physical channel.

Step 304: Judge whether the preset time is reached. If the preset time is reached, proceed to step 305; if the preset time is not reached, continue with step 303 to monitor and record the number of state changes of the SAS physical channel.

The preset time is a time period for monitoring and recording the number of state changes of the SAS physical channel, and is a time condition for judging whether the SAS physical channel is faulty.

Step 305: Judge whether the number of state changes of the SAS physical channel is greater than the preset threshold. If the number of state changes of the SAS physical channel is greater than the preset threshold, proceed to step 306; if the number of state changes of the SAS physical channel is not greater than the preset threshold, proceed to step 307.

The isolation condition illustrated in this embodiment is: The number of state changes of the SAS physical channel within the preset time is greater than the preset threshold. The isolation condition may also be: If the number of state changes of a SAS physical channel within the preset time is greater than or equal to the threshold, the SAS physical channel is regarded as faulty and needs to be isolated. The preset time and the threshold may be determined according to the device performance or the actual use conditions. For example, the preset time is 60s, the preset threshold is 3, and the isolation condition is that the number of state changes within 60s is greater than or equal to 3. That is, if the number of state changes of a SAS physical channel within 60s is greater than or equal to 3, the SAS physical channel fulfills the isolation condition and needs to be isolated.

Step 306: Isolate the SAS physical channel and proceed to step 307.

The isolation method may be: changing a value of a control register corresponding to the SAS physical channel to disable the SAS physical channel and therefore isolate the SAS physical channel.

Step 307: Judge whether the system running is completed. If the system running is completed, end the procedure; if the system running is not completed, continue with step S301.

In the method provided in the third embodiment, to improve accuracy of isolating the SAS physical channel, a register is preset in the SAS expansion device to monitor whether the SAS physical channel is connected to a storage device. If the SAS physical channel is not connected to a storage device, the number of state changes of the SAS physical channel is cleared to zero so that the SAS physical channel is not mistakenly regarded as faulty or mistakenly isolated when the storage device such as a hard disk or a concatenated SAS expansion device is repeatedly inserted and removed. This improves accuracy of isolating the SAS physical channel, enables other SAS physical channels to transmit data normally without being affected by the faulty SAS physical channel, and ensures stable running of the whole SAS domain.

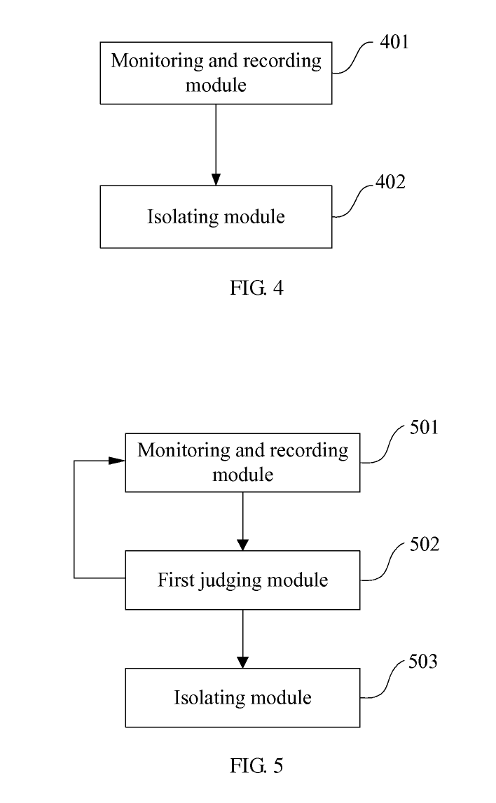

FIG. 4 shows a structure of an apparatus for improving running stability of a SAS domain in a fourth embodiment of the present invention. As shown in FIG. 4, the apparatus includes a monitoring and recording module 401 and an isolating module 402.

The monitoring and recording module 401 is configured to monitor and record the number of state changes of each SAS physical channel in the SAS domain within a preset time.

The preset time is a time period for monitoring and recording the number of state changes of a SAS physical channel. The number of state changes of the SAS physical channel may be obtained by reading values of a monitoring register corresponding to the SAS physical channel. The monitoring register stores the absolute number of state changes of the SAS physical channel, and the number of state changes of the SAS physical channel may be obtained according to the difference between the absolute numbers of two adjacent state changes of the SAS physical channel.

The isolating module 402 is configured to isolate the SAS physical channel that fulfills a preset isolation condition according to a monitoring and recording result of the monitoring and recording module 401.

The isolation condition is set according to the device performance or the actual use conditions. The isolation condition may be: If the number of state changes of a SAS physical channel within a preset time is greater than (or, greater than or equal to) a threshold, the SAS physical channel is regarded as faulty and needs to be isolated. For example, the preset time is 60s, the preset threshold is 3, and the isolation condition is that the number of state changes within 60s is greater than or equal to 3. That is, if the number of state changes of a SAS physical channel within 60s is greater than or equal to 3, the SAS physical channel is regarded as faulty and needs to be isolated. The isolating module 402 can change a value of a control register corresponding to the SAS physical channel to disable the SAS physical channel and therefore isolate the SAS physical channel.

In the technical solution provided in the fourth embodiment, the monitoring and recording module 401 monitors and records the number of state changes of each SAS physical channel in the SAS domain within a preset time; if the number of state changes of a SAS physical channel fulfills the preset isolation condition, the SAS physical channel is regarded as faulty and is isolated by the isolating module 402 in time. This enables other SAS physical channels to transmit data normally without being affected by the faulty SAS physical channel, and ensures stable running of the whole SAS domain.

FIG. 5 shows a structure of an apparatus for improving running stability of a SAS domain according to a fifth embodiment of the present invention. As shown in FIG. 5, the apparatus includes a monitoring and recording module 501, a first judging module 502, and an isolating module 503.

The monitoring and recording module 501 is configured to monitor and record the number of state changes of each SAS physical channel.

The number of state changes of each SAS physical channel may be obtained by reading values of a monitoring register corresponding to the SAS physical channel. The monitoring register stores the absolute number of state changes of the SAS physical channel, and the number of state changes of the SAS physical channel may be obtained according to the difference between the absolute numbers of two adjacent state changes of the SAS physical channel.

The first judging module 502 is configured to: judge whether the state change of each SAS physical channel monitored by the monitoring and recording module 501 fulfills a preset isolation condition, and trigger the isolating module 503 if the isolation condition is fulfilled or trigger the monitoring and recording module 501 if the isolation condition is not fulfilled.

The isolation condition is set according to the device performance and the actual use conditions. The isolation condition may be: If the number of state changes of a SAS physical channel within a preset time is greater than (or, greater than or equal to) a threshold, the SAS physical channel is regarded as faulty and needs to be isolated. For example, the preset time is 60s, the preset threshold is 3, and the isolation condition is that the number of state changes within 60s is greater than or equal to 3. That is, if the number of state changes of a SAS physical channel within 60s is greater than or equal to 3, the SAS physical channel is regarded as faulty and the isolating module 503 is triggered.

The isolating module 503 is configured to isolate a SAS physical channel determined by the first judging module 502 as fulfilling the isolation condition.

The isolating module 503 can change a value of a control register corresponding to the SAS physical channel to disable the SAS physical channel and therefore isolate the SAS physical channel.

In the apparatus provided in the fifth embodiment, the monitoring and recording module 501 monitors and records the number of state changes of each SAS physical channel in the SAS domain within a preset time; the first judging module 502 judges whether the state change of a SAS physical channel monitored by the monitoring and recording module 501 fulfills the preset isolation condition; and the isolating module 503 isolates the SAS physical channel that fulfills the isolation condition. This enables other SAS physical channels to transmit data normally without being affected by the faulty SAS physical channel, and improves running stability of the whole SAS domain.

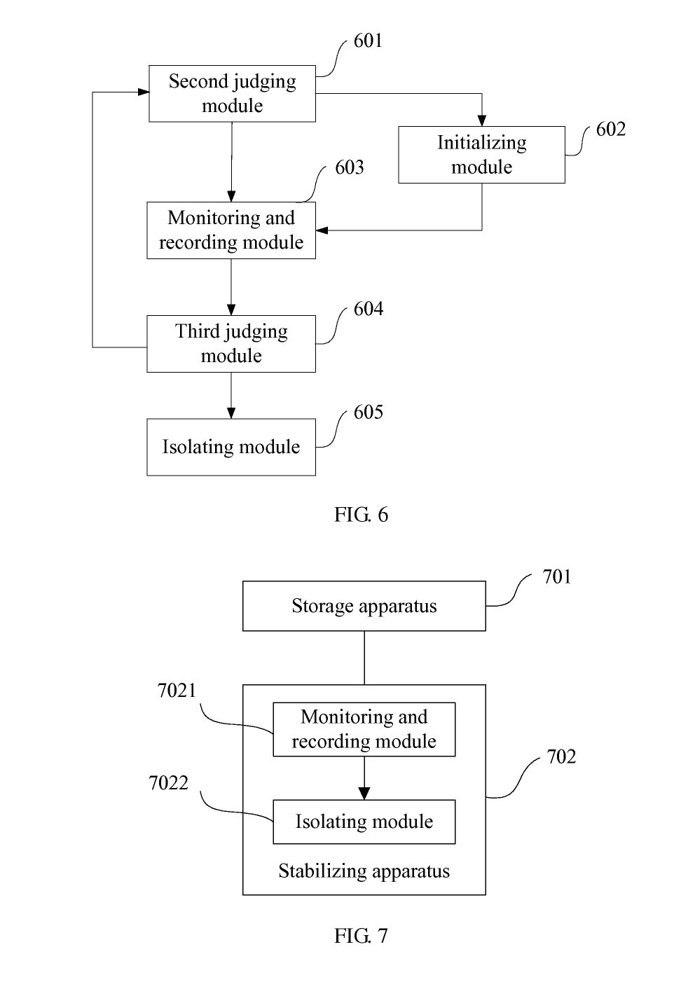

FIG. 6 shows a structure of an apparatus for improving running stability of a SAS domain according to a sixth embodiment of the present invention. As shown in FIG. 6, the apparatus includes a second judging module 601, an initializing module 602, a monitoring and recording module 603, a third judging module 604, and an isolating module 605.

The second judging module 601 is configured to: judge whether a SAS physical channel in the SAS domain is connected to a storage device, and trigger the monitoring and recording module 603 if the SAS physical channel is connected to a storage device or trigger the initializing module 602 if the SAS physical channel is not connected to a storage device.

The judging whether the SAS physical channel is connected to a storage device is based on a register preset in a SAS expansion device in the SAS domain. The register monitors whether the corresponding physical channel is connected to a storage device. The storage device may be a hard disk device or a concatenated SAS expansion device.

The initializing module 602 is configured to clear the number of state changes of the SAS physical channel to zero, and trigger the monitoring and recording module 603.

The number of state changes of the SAS physical channel is cleared to zero so that the SAS physical channel is not mistakenly regarded as faulty or mistakenly isolated because SAS physical channel disconnected from the storage device when the storage device, such as a hard disk or a concatenated SAS expansion device, is repeatedly inserted and removed manually.

The monitoring and recording module 603 is configured to monitor and record the number of state changes of the SAS physical channel, and trigger the third judging module 604.

The number of state changes of the SAS physical channel may be obtained by reading values of a monitoring register corresponding to the SAS physical channel. The monitoring register stores the absolute number of state changes of the SAS physical channel, and the number of state changes of the SAS physical channel may be obtained according to the difference between the absolute numbers of two adjacent state changes of the SAS physical channel.

The third judging module 604 is configured to: judge whether the state change of the SAS physical channel fulfills an isolation condition according to a recording result of the monitoring and recording module 603, and trigger the isolating module 605 if the isolation condition is fulfilled or trigger the second judging module 601 if the isolation condition is not fulfilled.

The isolation condition is set according to the device performance and the actual use conditions. The isolation condition may be: If the number of state changes of a SAS physical channel within a preset time is greater than (or, greater than or equal to) a threshold, the SAS physical channel is regarded as faulty and needs to be isolated. For example, the preset time is 60s, the preset threshold is 3, and the isolation condition is that the number of state changes within 60s is greater than or equal to 3. That is, if the number of state changes of a SAS physical channel within 60s is greater than or equal to 3, the SAS physical channel is regarded as faulty and the isolating module 605 is triggered.

The isolating module 605 is configured to isolate the SAS physical channel determined by the third judging module 604 as fulfilling the isolation condition.

The isolating module 605 can change a value of a control register corresponding to the SAS physical channel to disable the SAS physical channel and therefore isolate the SAS physical channel.

In the apparatus for improving the running stability of the SAS domain provided in the sixth embodiment, the second judging module 601 judges whether the SAS physical channel in the SAS domain is connected to a storage device; the initializing module 602 clears the number of state changes of the SAS physical channel that is not connected to a storage device, and triggers the monitoring and recording module; and the SAS physical channel that fulfills the isolation condition is isolated. In this way, the accuracy of isolating the SAS physical channel is improved, and the SAS physical channel is not mistakenly regarded as faulty or mistakenly isolated because the SAS physical channel disconnected from the storage device when the storage device is repeatedly inserted and removed manually. Thus the running stability of the whole SAS domain is improved.

FIG. 7 shows a structure of a storage system according to a seventh embodiment of the present invention. As shown in FIG. 7, the storage system includes:

a storage apparatus 701, configured to store data through at least two storage devices included in the storage apparatus, where the storage devices are connected to a stabilizing apparatus through SAS physical channels; and

the stabilizing apparatus 702, configured to monitor and record the number of state changes of each SAS physical channel in the storage apparatus 701, and isolate a SAS physical channel that fulfills a preset isolation condition according to the number of state changes.

The stabilizing apparatus 702 includes a monitoring and recording module 7021 and an isolating module 7022.

The monitoring and recording module 7021 is configured to monitor and record the number of state changes of each SAS physical channel in the SAS domain within a preset time.

The preset time is a time period for monitoring and recording the number of state changes of a SAS physical channel. The number of state changes of the SAS physical channel may be obtained by reading values of a monitoring register corresponding to the SAS physical channel. The monitoring register stores the absolute number of state changes of the SAS physical channel, and the number of state changes of the SAS physical channel may be obtained according to the difference between the absolute numbers of two adjacent state changes of the SAS physical channel.

The isolating module 7022 is configured to isolate a SAS physical channel that fulfills a preset isolation condition according to a monitoring and recording result of the monitoring and recording module 7021.

The isolation condition is set according to the device performance or the actual use conditions. The isolation condition may be: If the number of state changes of a SAS physical channel within a preset time is greater than (or, greater than or equal to) a threshold, the SAS physical channel is regarded as faulty and needs to be isolated. For example, the preset time is 60s, the preset threshold is 3, and the isolation condition is that the number of state changes within 60s is greater than or equal to 3. That is, if the number of state changes of a SAS physical channel within 60s is greater than or equal to 3, the SAS physical channel is regarded as faulty and needs to be isolated. The isolating module 7022 can change a value of a control register corresponding to the SAS physical channel to disable the SAS physical channel and therefore isolate the SAS physical channel.

In the storage system provided in the seventh embodiment, the stabilizing apparatus is used to enable stable running of the storage apparatus; the monitoring and recording module in the stabilizing apparatus monitors and records the number of state changes of the SAS physical channel connected to a storage device in the storage apparatus within a preset time, and judges whether the SAS physical channel is faulty according to the number of state changes of the SAS physical channel; the isolating module isolates the faulty SAS physical channel, enabling other SAS physical channels to transmit data normally without being affected by the faulty SAS physical channel, and improving running stability of the entire storage system.

It should be noted that the first judging module, the second judging module, and the third judging module in the embodiments of the present invention are only names for identifying the modules, and do not represent the order of the modules or restrict the functions of the modules.

Persons of ordinary skill in the art should understand that all or part of the steps of the method under the present invention may be implemented by a program instructing relevant hardware. The program may be stored in a computer readable storage medium. When the program runs, the steps of the method provided in any of the embodiments above can be performed. The storage medium may be a magnetic disk, a Compact Disk-Read Only Memory (CD-ROM), a Read Only Memory (ROM) or a Random Access Memory (RAM).

Although the invention is described through some exemplary embodiments, the invention is not limited to such embodiments. It is apparent that those skilled in the art can make modifications and variations to the invention without departing from the spirit and scope of the invention. The invention is intended to cover the modifications and variations provided that they fall within the scope of protection defined by the following claims or their equivalents.

What is claimed is:

1. A method for improving running stability of a Serial Attached Small Computer System Interface (SAS) domain, comprising:
monitoring and recording the number of state changes of each SAS physical channel in the SAS domain within a preset time; and
isolating one of the SAS physical channels that fulfills a preset isolation condition according to the number of state changes.

2. The method according to claim 1, wherein:
isolating one of the SAS physical channels that fulfills the preset isolation condition according to the number of state changes further comprises: changing a value of a control register corresponding to the SAS physical channel.

3. The method according to claim 1, wherein:
the number of state changes of each SAS physical channel is obtained by reading values of a monitoring register corresponding to the SAS physical channel.

4. The method according to claim 1, wherein:
the preset isolation condition is that the number of state changes of the SAS physical channel is greater than a preset threshold.

5. The method according to claim 1, further comprising:
judging whether the SAS physical channel is connected to a storage device, and clearing the number of state changes of the SAS physical channel that is not connected to a storage device to zero.

6. The method according to claim 3, wherein:
the number of state changes of each SAS physical channel is obtained according to a difference between the absolute numbers of two adjacent state changes by reading values of the monitoring register corresponding to the SAS physical channel.

7. An apparatus for improving running stability of a Serial Attached Small Computer System Interface (SAS) domain, comprising:
a monitoring and recording module, configured to monitor and record the number of state changes of each SAS physical channel in the SAS domain within a preset time; and
an isolating module, configured to isolate one of the SAS physical channels that fulfills a preset isolation condition according to a monitoring result of the monitoring and recording module.

8. The apparatus according to claim 7, wherein:
the monitoring and recording module obtains the number of state changes of each SAS physical channel by reading values of a monitoring register corresponding to the SAS physical channel.

9. The apparatus according to claim 7, wherein:
the isolating module isolates the SAS physical channel by changing a value of a control register corresponding to the SAS physical channel.

10. The apparatus according to claim 7, wherein:
the preset isolation condition is that the number of state changes of the SAS physical channel is greater than a preset threshold.

11. The apparatus according to claim 7, further comprising:
a first judging module, configured to: judge whether the number of state changes of each SAS physical channel monitored by the monitoring and recording module fulfills the preset isolation condition, and perform one of the following: (a) trigger the isolating module if the isolation condition is fulfilled, and (b) trigger the monitoring and recording module if the isolation condition is not fulfilled.

12. The apparatus according to claim 7 further comprising:
a second judging module, configured to: judge whether the SAS physical channel is connected to a storage device, and perform one of the following: (a) trigger the monitoring and recording module if the SAS physical channel is connected to a storage device, and (b) trigger an initializing module if the SAS physical channel is not connected to a storage device;
the initializing module, configured to clear the number of state changes of the SAS physical channel to zero, and trigger the monitoring and recording module; and
a third judging module, configured to: judge whether state changes of the SAS physical channel fulfills the isolation condition according to a recording result of the monitoring and recording module, and perform one of the following: (a) trigger the isolating module if the isolation condition is fulfilled, and (b) trigger the second judging module if the isolation condition is not fulfilled.

13. A storage system, comprising:
a storage apparatus, configured to store data through at least two storage devices comprised in the storage apparatus, wherein the storage devices are connected to a stabilizing apparatus through Serial Attached Small Computer System Interface (SAS) physical channels; and
the stabilizing apparatus, configured to monitor and record the number of state changes of each SAS physical channel in the storage apparatus, and isolate an SAS physical channel that fulfills a preset isolation condition according to the number of state changes.

14. The storage system according to claim 13, wherein the stabilizing apparatus comprises:
a monitoring and recording module, configured to monitor and record the number of state changes of the SAS physical channel in an SAS domain within a preset time; and
an isolating module is configured to isolate the SAS physical channel that fulfills the preset isolation condition according to a monitoring and recording result of the monitoring and recording module.

15. The storage system according to claim 14, wherein:
the monitoring and recording module obtains the number of state changes of each SAS physical channel by reading values of a monitoring register corresponding to the SAS physical channel.

16. The storage system according to claim 14, wherein:
the isolating module isolates the SAS physical channel by changing a value of a control register corresponding to the SAS physical channel.

17. The storage system according to claim 14, wherein:
the preset isolation condition is that the number of state changes of the SAS physical channel is greater than a preset threshold.

18. The storage system according to claim 14, further comprising:
a first judging module, configured to: judge whether the number of state changes of each SAS physical channel monitored by the monitoring and recording module fulfills the preset isolation condition, and perform one of the following: (a) trigger the isolating module if the isolation condition is fulfilled, and (b) trigger the monitoring and recording module if the isolation condition is not fulfilled.

19. The storage system according to claim 14, wherein: further comprising:
a second judging module, configured to: judge whether the SAS physical channel is connected to a storage device, and trigger the monitoring and recording module if the SAS physical channel is connected to a storage device or trigger an initializing module if the SAS physical channel is not connected to a storage device;
the initializing module, configured to clear the number of state changes of the SAS physical channel to zero, and trigger the monitoring and recording module; and
a third judging module, configured to: judge whether state changes of the SAS physical channel fulfill the isolation condition according to a recording result of the monitoring and recording module, and perform one of the following: (a) trigger the isolating module if the isolation condition is fulfilled, and (b) trigger the second judging module if the isolation condition is not fulfilled.
